(19) United States
(12) Patent Application Publication
(10) Pub. No.: US 2026/0154948 A1
(43) Pub. Date: Jun. 4, 2026

(54) METHOD FOR IMAGE PROCESSING, ELECTRONIC DEVICE AND PROGRAM PRODUCT

(71) Applicant: KONINKLIJKE PHILIPS N.V., EINDHOVEN (NL)

(72) Inventors: WENJIN YU, SHANGHAI (CN); XIN GE, SHANGHAI (CN); YUEHUA LIU, SHANGHAI (CN)

(21) Appl. No.: 19/123,797

(22) PCT Filed: Nov. 7, 2023
(86) PCT No.: PCT/EP2023/080900

§ 371 Date: Apr. 24, 2025

(30) Foreign Application Priority Data
Nov. 8, 2022 (CN) 202211393752.X

(51) Int. Cl. G06V 10/774; G06F 40/284; G06F 40/30; G06V 10/44; G06V 10/764; G06V 20/70

(52) U.S. Cl. CPC G06V 10/7747; G06F 40/284; G06F 40/30; G06V 10/44; G06V 10/764; G06V 20/70; G06V 2201/03

(57) ABSTRACT

Embodiments of the present disclosure relate to a method for image processing, an electronic device, and a computer program product. The method comprises: acquiring a training data set comprising a medical image and a corresponding annotated text, wherein the annotated text includes classification information of the medical image and descriptive information associated with the classification information. The method further includes: training an image interpretation model using the training data set, wherein the image interpretation model comprises a first computing model for extracting an image feature from the medical image. and a second computing model for generating a text from the image feature. In this way, an input medical image can be classified together with a reason of such classification result. As a result, the classification is more trustworthy with improved user experience.

### FIELD

Embodiments of the present disclosure relate to a field of computers, and more particularly, to a method for image processing, an electronic device, and a computer program product.

### BACKGROUND

With the technical development of image processing, some image processing models are used for image classification with good accuracy. Some image processing models may output classification of images, and some image processing models may output simple texts of what objects are included in the images. These image processing models typically have neural units, which simulate the ability of human for processing information. However, a large amount of pre-annotated data is needed as training data to train the image processing models such that these neural units can learn the relationship between input and output through model parameters.

### SUMMARY

According to embodiments of the present disclosure, provided are an image processing method, an electronic device, and a computer program product.

According to a first aspect of the present disclosure, provided is a method for image processing. The method includes acquiring a training data set comprising a medical image and a corresponding annotated text, wherein the annotated text comprises classification information of the medical image and descriptive information associated with the classification information. The method further includes training an image interpretation model using the training data set, wherein the image interpretation model comprises a first computing model for extracting an image feature from the medical image and a second computing model for generating a text from the image feature.

According to a second aspect of the present disclosure, provided is an electronic device, including: at least one processing unit and at least one memory coupled to the at least one processing unit and storing instructions for execution by the at least one processing unit, wherein the instructions, when executed by the at least one processing unit, cause a computing device to execute a method. The method includes acquiring a training data set comprising a medical image and a corresponding annotated text, wherein the annotated text comprises classification information of the medical image and descriptive information associated with the classification information. The method further includes training an image interpretation model using the training data set, wherein the image interpretation model comprises a first computing model for extracting an image feature from the medical image, and a second computing model for generating a text from the image feature.

According to a third aspect of the present disclosure, provided is a computer program product including machine-executable instructions, wherein the machine-executable instructions, when executed by a device, cause the device to perform the method according to the first aspect of the present disclosure.

The Summary is provided to introduce the selection of concepts in a simplified form, and the concepts will be further described below in the Detailed Description. The Summary is not intended to identify key features or primary features of the claimed theme, nor is it intended to limit the scope of the claimed theme.

### BRIEF DESCRIPTION OF THE DRAWINGS

The above and other features, advantages and aspects of various embodiments of the present disclosure will become more apparent from the following detailed description in conjunction with the drawings. In the drawings, the same or similar reference signs denote the same or similar elements, wherein:

FIG. 1 illustrates a block diagram of an example environment in which some embodiments of the present disclosure may be implemented;

FIG. 2 illustrates a schematic flowchart of a method for image processing according to embodiments of the present disclosure;

FIG. 3A illustrates a schematic diagram of an image feature extraction process in a first computing model according to embodiments of the present disclosure;

FIG. 3B illustrates a schematic diagram of an image feature output process in the first computing model according to embodiments of the present disclosure;

FIG. 4 illustrates a schematic diagram of a process of determining attention in the first computing model according to embodiments of the present disclosure;

FIG. 5 illustrates a schematic diagram of a process of generating a text sequence in a second computing model according to embodiments of the present disclosure;

FIG. 6 illustrates a schematic diagram of a process of determining a lexicon according to embodiments of the present disclosure;

FIG. 7 illustrates a schematic diagram of comparison between embodiments of the present disclosure and an image subtitle; and

FIG. 8 illustrates a schematic block diagram of an example device that may be used for implementing some embodiments according to the present disclosure.

In all drawings, the same or similar reference signs denote the same or similar elements.

### DETAILED DESCRIPTION OF EMBODIMENTS

Hereinafter, embodiments of the present disclosure will be described in more detail with reference to the drawings. Although some embodiments of the present disclosure have been illustrated in the drawings, it should be understood that the present disclosure may be implemented in various forms and should not be construed as being limited to the embodiments set forth herein; and rather, these embodiments are provided to help understand the present disclosure more thoroughly and completely. It should be understood that the drawings and embodiments of the present disclosure are for exemplary purposes only and are not intended to limit the protection scope of the present disclosure.

In the description of the embodiments of the present disclosure, the terms “include” and similar terms thereof should be understood as open-ended inclusion, i.e., “including, but not limited to”. The term “based on” should be understood as “based, at least in part, on”. The term “one embodiment” or “the embodiment” should be understood as “at least one embodiment”. The terms “first”, “second” and the like may refer to different or identical objects. Other explicit and implicit definitions may also be included below. In addition, specific numerical values herein are examples, and are merely intended to help understanding rather than limiting the scope.

With the rapid growth of artificial intelligence (AI) in the field of medical care, regulatory authorities have started drawing and publishing new regulations and standards for medical devices based on artificial intelligence, which have a significant impact on the landing of artificial intelligence medical products on the market. Although artificial intelligence, especially deep learning (DL), has made significant success in various fields and applications, compared with conventional machine learning methods such as a decision tree and a support vector machine (SVM), DL-based methods are generally based on black box algorithms and are relatively weak in terms of interpreting their inference processes.

A DL algorithm belonging to a black box typically learns a mapping function of input and output by means of training a neural network having a plurality of hidden layers. The DL algorithm is based on a large amount of training data and high computing power. By means of the training process, features are automatically learned, which are difficult to interpret with professional knowledge in the medical field. Traditional white box machine learning methods manually design and extract features on the basis of expert's domain knowledge, thus having better interpretability.

Therefore, relying on the traditional technology, it is only known that the deep learning technology may remarkably improve the performance of various applications and tasks through experimental verification. However, why a DL model can provide a correct result, and what information the model is based on to provide such correct decision still lack very clear answers and lack a theoretical basis for supporting and confirming the deep learning capability. In particular, in the field of medical care, not only the regulatory authorities gradually start to require AI medical devices to provide algorithm interpretability, but doctors also start to expect trustworthy interpretations of AI products. Therefore, lacking interpretability and confidence of the DL method is a critical problem that needs to be resolved.

In view of this, an embodiment of the present disclosure provides an image processing solution. In the solution, in the present invention, an image interpretation generator is proposed, which may provide a result and description of classifying a medical image for aided diagnosis. The image is annotated by an experienced expert using a paragraph of texts, and words or phrases in the paragraph are extracted and grouped into a data set as a standardized lexicon (also referred to as a dictionary). A deep learning model with two module structures is used as a basis for training. An output paragraph is generated word by word or phrase by phrase, each word or phrase is selected from the previously defined lexicon. In this way, not only can the input medical image be classified, but also the reason of generating the classification result is provided. As a result, the classification result is more trustworthy with improved user experience and the regulation requirements of related departments are also met.

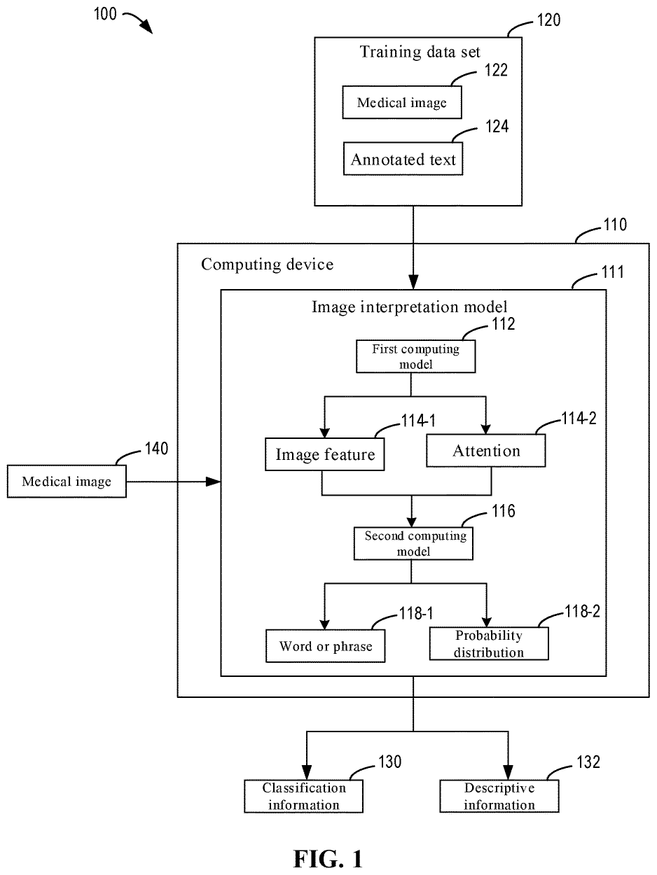

Some example embodiments of the present disclosure will be described below with continued reference to FIG. 1 to FIG. 8. It should be noted that, for ease of understanding, the embodiments of the present disclosure are described hereinafter by taking a medical image as an example, but the embodiments of the present disclosure are also applicable to images of any other types. In this case, annotation information will be given by a person having domain knowledge. In addition, a classification task is taken as an example for description below, but the embodiments of the present disclosure are also applicable to image processing tasks of other types, such as target detection, target recognition, target tracking, and the like. The present disclosure is not limited in the above aspects.

FIG. 1 illustrates a block diagram of an example environment 100 in which some embodiments of the present disclosure may be implemented. The example environment 100 generally depicts various exemplary elements participating in the method proposed in the present disclosure. The environment 100 includes a computing device 110. The computing device 110 may be, for example, a computing system or a server. The computing device 110 includes an image interpretation model 111 to provide an image processing function. In some embodiments, the computing device 110 may store a code with an indication, so as to provide the image processing function.

The example environment 100 further includes a training data set 120. The training data set 120 includes a medical image 122 and a corresponding annotated text 124. It can be understood that, for brevity, the medical image 122 is a general term of a plurality of medical images. The annotated text 124 is also a general term, which includes a plurality of annotated texts corresponding to the plurality of medical images.

The medical image is generally understood as an image for a human body or a particular part, which is acquired by a medical imaging device. For example, images for the stomach, kidney, liver, lung and the like, which are obtained using X-ray, ultrasonic waves, compuerized tomography (CT), or magnetic resonance imaging (MRI) technology, etc.

The medical image is annotated by an experienced doctor to obtain a correct classification result and a reason why is it classified in this way, and the medical image is used as the annotated text. For example, for a medical image with a lesion of liver, the annotated text may be a “LI-RADS (liver image report and data system) level-4 lesion in the liver, because the size is large, there are an enhanced envelope and non-peripheral flushing”.

The training data set 120 is provided to train the image interpretation model 111. The image interpretation model 111 includes a first computing model 112 for extracting a feature from the image, and a second computing model 116 for generating classification information and a corresponding descriptive text according to the extracted image feature. Specifically, the first computing model 112 extracts an image feature 114-1 and determines a corresponding attention 114-2. It is worth noting that, for the convenience of illustration, the image feature 114-1 and the attention 114-2 herein are also abstract concepts, which include a plurality of image features and a plurality of corresponding attentions. The attention may be understood as a weight, which reflects the degree of attention of the corresponding image feature, and generally, the attention of an unimportant image feature (for example, a background) is relatively low. While, the attention of the lesion is relatively high.

The image feature 114-1 and the attention 114-2 are input into the second computing model 116. On the basis of the image feature 114-1 and the attention 114-2, the second computing model 116 generates words and phrases 118-1 constituting the descriptive text, and a corresponding probability distribution 118-2. A sentence is formed by the words or phrases with the highest probability, and then a paragraph is formed. This paragraph includes classification information 130 and descriptive information 132. The descriptive information 132 may interpret why the image is classified as the result.

The example environment 100 may further include a medical image 140 to be processed. The medical image 140 and the medical image 122 basically have no difference in terms of physical acquisition mode, which are both medical images of human organs, but have differences in applications. When the image interpretation model 111 is trained and is applied to an inference phase, the medical image 140 is used for performing an image classification task. Generally speaking, the training data set 120 is used in a training phase, the medical image 140 is used in the inference phase. That is, the training data set and the medical image are not used at the same time.

The environment 100 in which the embodiments of the present disclosure may be implemented is described above with reference to FIG. 1. It should be understood that the environment 100 is merely exemplary, and the embodiments of the present disclosure may be implemented in other environments different from this. For example, the training data set 120 and the medical image 140 may be implemented in the same or different devices.

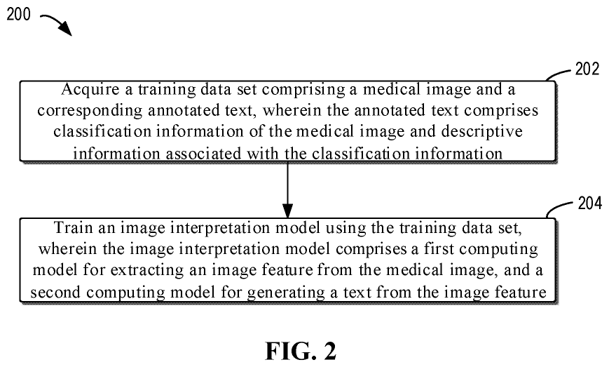

FIG. 2 illustrates a schematic flowchart of a method 200 for image processing according to embodiments of the present disclosure. For ease of description, the method 200 may be implemented in the computing device 110 shown in FIG. 1. It should be understood that, the method 200 may also include additional actions not shown and/or may omit the illustrated actions, and the scope of the present disclosure is not limited in this regard. For ease of understanding, the method 200 is illustrated in combination with FIG. 1.

At block 202, a training data set is acquired, wherein the training data set includes a medical image and a corresponding annotated text, and the annotated text includes classification information of the medical image and descriptive information associated with the classification information. As an example, the computing device 110 may acquire the training data set 120, wherein the training data set 120 may include a medical image 122. The medical image 122 may be an image of a lesion of each type, and each image is formed by the medical imaging device. For each medical image subjected to imaging, it may be annotated with expert experience as the annotated text 124 for training the image interpretation model. The annotated text 124 includes a classification result of the medical image 122, and descriptive information of the classification result. The descriptive information is not a simple sentence, but describes the reason of generating the classification result in detail. For example, for a liver tumor, the descriptive information may include, for example, size and form information of the tumor.

In some embodiments, the descriptive information is determined on the basis of medical standards. As an example, it is assumed that liver tumors have 5-level classification, and each level has corresponding tumor size and form. Then, the classification and description of the medical image of the liver should be determined according to the annotation. For the descriptive information, standard medical vocabularies and correct grammars should also be used to ensure the applicability of the image interpretation model to the public.

At block 204, the image interpretation model is trained using the training data set, wherein the image interpretation model includes a first computing model for extracting an image feature from the medical image, and a second computing model for generating a text from the image feature. As an example, the first computing model 112 may be used for extracting an image feature, and the second computing model 116 may be used for generating classification information of a particular medical image and a descriptive text for interpreting why the particular medical image corresponds to the classification result.

As an example, in a LI-RADS system, liver lesions may be classified into five levels. The higher the level is, the more serious the disease is. There is a standard in conventional diagnosis, that is, the size, the presence of an enhanced envelope and non-peripheral flushing may directly result in a diagnostic decision. Terms such as “size”, “large”, “small”, “medium”, “presence of enhanced envelope”,“ presence of non-peripheral flushing” and the like are defined as standardized words. According to the standardized medical standards, each input image is translated into a paragraph of text interpretation by a doctor.

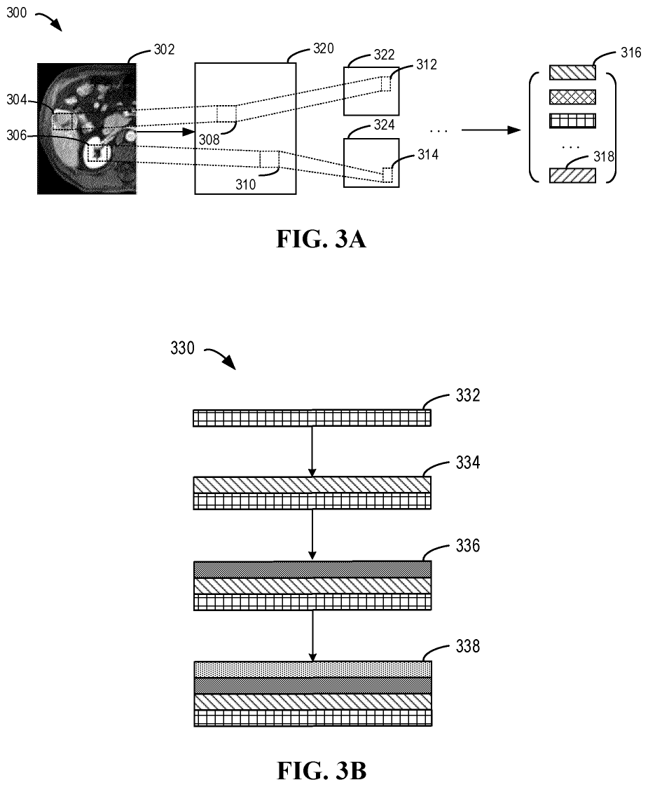

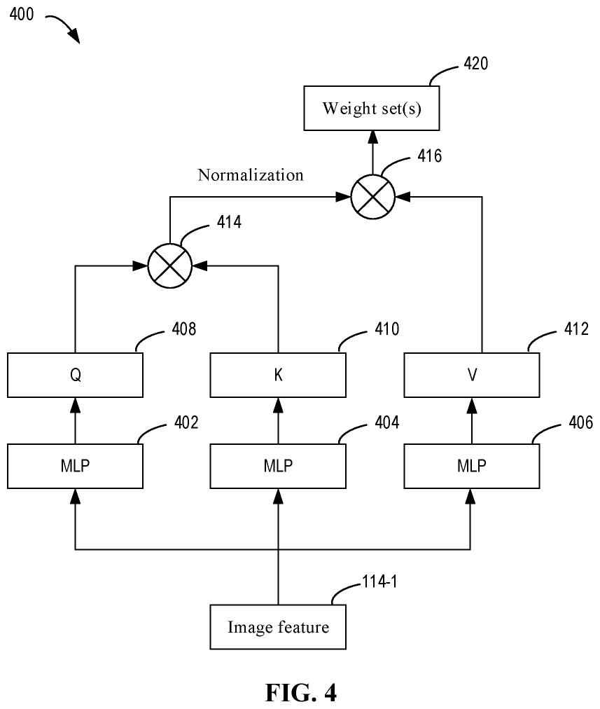

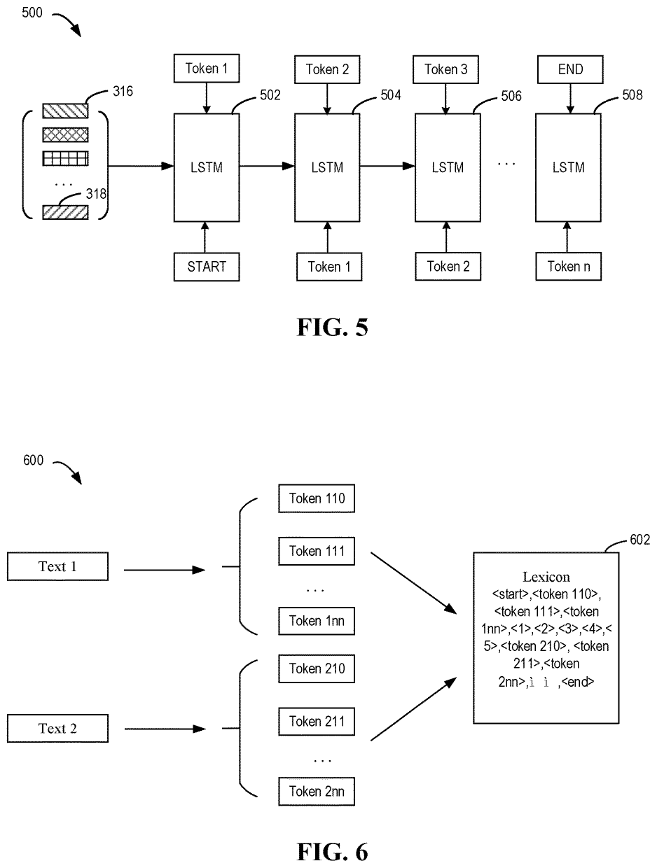

The detailed structure and application process of the first computing model 112 will be described with reference to FIG. 3A, FIG. 3B and FIG. 4, and the detailed structure and application process of the second computing model 116 will be described with reference to FIG. 5, therefore the first computing model 112 and the second computing model 116 are not described in detail herein.

By means of the method 200, the input medical image may be classified, and a reason of generating the classification result is provided. Since the descriptive information of the classification result is a human understandable text and is not a simple sentence, but includes a specific reason, the classification result is more easily accepted by people, so that the classification result is more trustworthy, thereby providing more user-friendly experience.

FIG. 3A illustrates a schematic diagram of an image feature extraction process 300 in the first computing model according to embodiments of the present disclosure. As shown in FIG. 3A, a medical image 302 may be divided into small blocks, for example, an image block 304 and an image block 306, these small blocks may have N×N pixels, which may have the same or different sizes. An image feature may be extracted from the image block 304 by a convolution layer 320 of the first computing model 112. An image feature may also be extracted from the image block 306 by the convolution layer 320 of the first computing model 112. The convolution layer 320 has a convolution kernel that is sensitive to a particular feature, so that a feature of interest can be extracted using the convolution kernel. The first computing model 112 may have a plurality of convolution layers, for example, a convolution layer 320, a convolution layer 322 and a convolution layer 324. Each convolution layer may have a convolution kernel interested in different features.

After the feature extraction of the image block 304 through the convolution layer 320, a latent vector 308 may be obtained. A feature may be continuously extracted from the latent vector 308 by the convolution layer 322, so as to generate a latent vector 312, and such process may be performed for multiple times, so that an image feature 316 is generated finally. Similarly, after the feature extraction of the image block 306 through the convolution layer 320, a latent vector 310 may be obtained. A feature may be continuously extracted from the latent vector 310 by the convolution layer 324, so as to generate a latent vector 314, and such a process may be performed for multiple times, so that an image feature 318 is generated finally.

In this way, after the medical image 302 is processed by a plurality of convolution layers, corresponding image features may be extracted to generate a plurality of image features such as the vector 316 and the vector 318. It can be understood that, in the field of deep learning, the feature is an abstract concept, which does not necessarily correspond to a certain or some physical meanings of a target object, and the feature is generally represented by a vector.

FIG. 3B illustrates a schematic diagram of an image feature output process 330 in the first computing model according to embodiments of the present disclosure. In the field of image processing, one image is generally represented using an RGB or YUV color system. In this way, one image generally has a plurality of image channels. As shown in FIG. 3B, the features of each image channel may be superimposed to form a final image feature. For example, an image feature 332 of a first image channel and an image feature 334 of a second image channel are concatenated together, and then are concatenated with a third feature 336 of a third image channel.

In some embodiments, these image features also have corresponding attentions. For example, the attention may be a weight set 338. The weight set 338 and a concatenated vector matrix are output to the second computing model 116 as a whole. The process and module for determining the attention will be specifically described below with reference to FIG. 4.

In some embodiments, based on the image channels of the medical image, an image channel weight set associated with the image channels is determined. As an example, image features of three YUV image channels may be determined on the basis of the medical image 302.

In some embodiments, based on spatial distribution of objects in the medical image, a spatial weight set associated with the space is determined. As an example, if a lesion region of the liver is of interest, the weight of the lesion may be adjusted to be greater, while the weights of the region of other organs and image backgrounds are adjusted to be smaller.

In some embodiments, the image feature is determined based on the image channel weight set and the spatial weight set. As an example, the weight set may be concatenated with the image feature extracted by the convolution layer, so as to form an image feature output to the second computing model 116.

By means of the process 300 and the process 330, the feature of a region of interest related to the lesion and the weight of the feature may be determined, so that the feature is not interfered by other noises, and thus the classification and description of the image are more accurate.

FIG. 4 illustrates a schematic diagram of a process 400 of determining the attention in the first computing model according to embodiments of the present disclosure. In some embodiments, the process 400 may be configured to be executed in the process 300. As an example, the process 400 may be embedded into each convolution layer in a CNN network (e.g., the convolution layer 320, the convolution layer 322 and the convolution layer 324 of FIG. 3A), and the corresponding attention is extracted by the convolution layer. In some embodiments, the process 400 may be executed by a specialized attention module, and the attention module extracts the corresponding attention.

As shown in FIG. 4, the image feature 114-1 may be respectively input to, for example, three full-connected layers (which may be referred to as multi-layer perceptrons (MLPs)): a full-connected layer 402, a full-connected layer 404 and a full-connected layer 406. Therefore, three vectors, that is, a vector Q 408, a vector K 410 and a vector V 412, may be obtained respectively, wherein the vector Q 408 and the vector K 410 may be multiplied at block 414 and normalized (softmax). The normalized vector is multiplied by the vector V 412 at block 416, so as to generate a weight set 420.

In the process 400, the vector Q acts as a query vector, the vector 410 as a key vector, and the vector 412 as a value vector. The importance of the query vector is determined by the similarity between the query vector and the key vector with reference to the value vector, and is reflected on its weight. It can be understood that, the process 400 may be repeated for multiple times to provide supplements for each other, so as to prevent missing details, thereby achieving the purpose of paying full attention to details that should be paid attention to.

FIG. 5 illustrates a schematic diagram of a process 500 of generating a text sequence in the second computing model according to embodiments of the present disclosure. As described in FIG. 5, the second computing model 116 may include several predicting units. For example, the computing model 116 includes a sequence-to-sequence model, the sequence-to-sequence model includes a plurality of predicting units 502, 504, 506 and 508, which are connected in series, and each predicting unit is configured to output a predicted word or phrase. It can be understood that, FIG. 5 is merely an example, and the second computing model may have more predicting units.

In some embodiments, the image feature output from the first computing model 112 is input into a first predicting unit, such as the predicting unit 502. As an example, the predicting unit may be a long short-term memory network (LSTM). In other examples, the predicting unit may also be a transformer or BERT.

In some embodiments, for a predicting unit among the plurality of predicting units connected in series, the predicting unit may receive, as an input, a word or phrase generated by the previous predicting unit; and the predicting unit may output a predicted word or phrase to the next predicting unit.

As an example, [START] is a default input of the predicting unit 502 and is used as start. The predicting unit 502 outputs the probability distribution of a first token according to the image feature. In some embodiments, the predicting unit 502 outputs the probability distribution of the first token 1 according to the image feature and the attention (e. g, the weight set).

In some embodiments, the token is determined according to a lexicon. The probability distribution represents the probability of each word in the lexicon. The determination of the lexicon will be described below with reference to FIG. 6, which is not described in detail herein.

In the predicting unit 504, the token 1 output from the predicting unit 502 will be processed to generate a second token 2. In some embodiments, the token 1 output from the predicting unit 502 and the attention thereof will be processed to generate the second token 2.

In the predicting unit 506, the token 2 output from the predicting unit 504 will be processed to generate a third token 3. In some embodiments, the token 2 output from the predicting unit 504 and the attention thereof will be processed to generate the third token 3.

In some embodiments, the predicting unit receiving, as the input, the word or phrase generated by the previous predicting unit includes: in a first predicting unit, on the basis of the image feature and the attention of the image feature, determining a first semantic feature associated with the image feature. For example, in the predicting unit 502, the first semantic feature associated with the image feature is determined on the basis of the image feature 114-1 and the attention of the image feature.

In some embodiments, on the basis of the first semantic feature, the probability distribution of the word or phrase output from the first predicting unit is determined. For example, on the basis of the first semantic feature, the probability distribution of the word or phrase output from the predicting unit 502 is determined, and the token 1 is determined according to the probability distribution.

In some embodiments, in a second predicting unit, on the basis of the first semantic feature and the attention of the first semantic feature, a second semantic feature associated with the first semantic feature is generated. On the basis of the second semantic feature, the probability distribution of the word or phrase output from the second predicting unit is determined. For example, in the predicting unit 504, the second semantic feature associated with the first semantic feature may be generated based on the first semantic feature and the attention of the first semantic feature. Based on the second semantic feature, the probability distribution of the word or phrase output from the predicting unit 504 is determined, and the token 2 is determined according to the probability distribution.

Such a serial process may continue until the end, at this time, the predicting unit will output [END]. For example, when a user inputs a medical image, words are generated one by one until a paragraph is completed. The generated paragraph consists of two parts, the first sentence may summarize the diagnosis result, and the rest interprets why the result is obtained. It can be seen that the classification result of the medical image and the corresponding descriptive text are generated using such a serial structure via the image feature and the attention. This is a complete paragraph, including the classification result and the reason, and thus has better interpretability and is more believable to human. This also simplifies the workload of medical staff, and can provide effective aided diagnosis.

FIG. 6 illustrates a schematic diagram of a process 600 for determining the lexicon according to embodiments of the present disclosure. As shown in FIG. 6, an interpretation text or sentence is split into some words or phrases, and then these words or phrases are collected to establish the lexicon. Once all images are annotated, all words or phrases in the paragraph will be split, extracted and then collected into a lexicon, which is a set consisting of all words or phrases without repetition. It should be noted that the lexicon needs to include <START> and <END> to indicate the start and end of the paragraph.

In some embodiments, training the image interpretation model using the training data set includes: performing word segmentation on a text in the training data set, so as to acquire a lexicon for generating the text; and training the second computation model on the basis of the lexicon, so that words or phrases in the text generated by the second computation model are included in the lexicon.

For example, word segmentation is performed on a text 1 to obtain a token 110 to a token 1nn, and word segmentation is performed on a text 2 to obtain a token 210 to a token 2nn. These tokens are added into a lexicon 602, and image classification levels, for example, numbers 1 to 5, are also added into the lexicon 602.

In some embodiments, the granularity of the lexicon is a character. In some embodiments, the granularity of the lexicon is a word. In some embodiments, the granularity of the lexicon is a phrase or a word group. It can be understood that these granularities may be determined according to the training effect. For example, the tokens for training are generated using different word segmentation standards. These tokens with different granularities may be mixed for use. For example, the granularity of the word or phrase may be compatible with the granularity of the character. Corresponding to English, the minimum granularity is a single word, and a letter is not used as the granularity, unless one letter is a single word, for example, the article a.

It can be seen that, the lexicon established in this way is specifically directed to the medical field, therefore the vocabularies included therein are specific, the number is relatively reduced, and the vocabularies are relatively accurate. Such a process 600 may reduce the computing overheads, and the efficiency of outputting the classification result and descriptive text is improved by the computing speed of the image interpretation model.

In some embodiments, the first computing model includes at least a part of a pre-trained model, and training the image interpretation model using the training data set includes: freezing parameters of the first computing model; and updating parameters of the second computing model.

As an example, the first training model 112 may be some image classification models that have been commercially pre-trained, which may be specifically trained on the basis of the training data set 120 to conform to a particular scenario of medical image classification. In some embodiments, the first computing model may be trained first, the parameters thereof are frozen, then the second computing model 116 is trained, and the parameters of the second computing model are updated until the requirements are met. Alternatively, in some embodiments, the first computing model may be trained first, the parameters thereof are frozen, then the second training model is trained, and the parameters of the second computing model are updated. Then, the parameters of the second model are frozen, and the parameters of the first model are updated on the basis of a loss function of the second model. The iterative alternate training is performed by parity of reasoning until the requirements are met.

In some embodiments, the classification information includes aided diagnosis information for the medical image, and the descriptive information includes description for one or more objects of the medical image, for example, description of lesions for different organs of the human body.

In some embodiments, classification information including the input medical image and a descriptive text for interpreting the classification information are generated from the input medical image using the trained image interpretation model. For example, after the image interpretation model is trained and put into actual use, the trained image interpretation model generates, from the input medical image 140, classification information 130 including the input medical image and descriptive information 132 for interpreting the classification information 130.

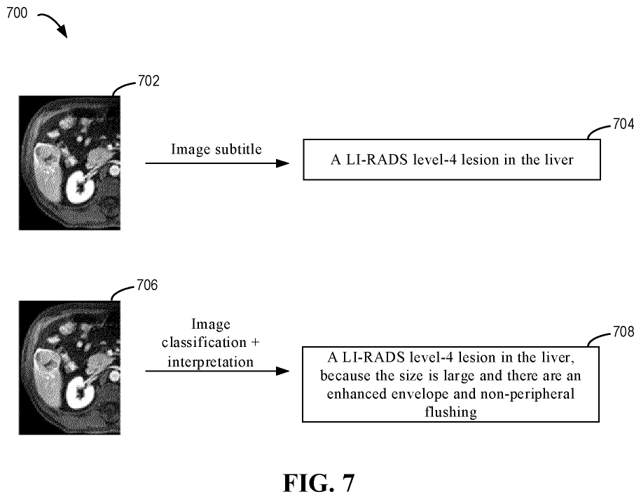

FIG. 7 illustrates a schematic diagram of comparison 700 between an embodiment of the present disclosure and an image subtitle. As shown in FIG. 7, an image 702 and an image 706 are similar medical images. By using a traditional image subtitle mode, a sentence of “LI-RADS level-4 lesion in the liver” as shown in 704 may be obtained, and the classification reason is unknown. However, by using the image processing solution proposed in the present disclosure, a paragraph of sentence of “LI-RADS level-4 lesion in the liver, and because the size is large, there are an enhanced envelope and non-peripheral flushing” as shown in 708 may be obtained, wherein the first sentence summarizes the diagnosis result, and the rest interprets why the result is obtained. As can be seen, the effect of the description 708 is much better than the effect of the description 704, the description 708 has detailed and contrastive reasons, and the classification thereof is made based on medical standards.

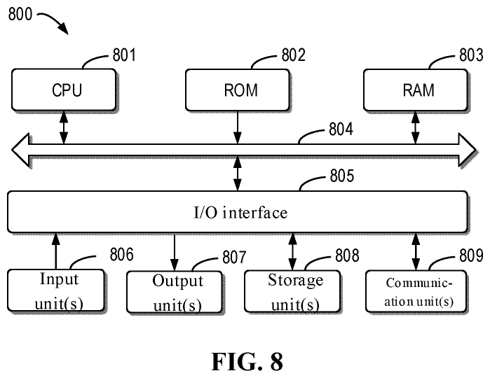

FIG. 8 illustrates a schematic block diagram of an example device 800 that may be used for implementing some embodiments according to the present disclosure. As shown in FIG. 8, the device 800 includes a central processing unit (CPU) 801, which may perform various suitable actions and processes in accordance with a computer program instruction stored in a read only memory (ROM) 802 or a computer program instruction loaded from a storage unit 808 into a random access memory (RAM) 803. In the RAM 803, various programs and data needed by the operations of the device 800 are also stored. The CPU 801, the ROM 802 and the RAM 803 are connected to each other via a bus 804. An input/output (I/O) interface 805 is also connected to the bus 804.

A plurality of components in the device 800 are connected to the I/O interface 805, including: input unit(s) 806, for example, a keyboard, a mouse, and the like; output unit(s) 807, for example, displays of various types, a speaker, and the like; storage unit(s) 808, for example, a magnetic disk, an optical disk, and the like; and communication unit(s) 809, for example, a network card, a modem, a wireless communication transceiver, and the like. The communication unit(s) 809 allows the device 800 to exchange information/data with other devices by means of a computer network such as the Internet and/or various telecommunication networks.

The various processes and processing described above, such as the method 200 or the process 300, the process 330, the process 400, the process 500 and the process 600, may be executed by the processing unit 801. For example, in some embodiments, one or more of the method 200, the process 300, the process 330, the process 400, the process 500 and the process 600 may be implemented as a computer software program, which is tangibly embodied in a machine-readable medium, such as the storage unit 808. In some embodiments, all or all of the computer program may be loaded and/or installed onto the device 800 via the ROM 802 and/or the communication unit 809. When the computer program is loaded to the RAM 803 and executed by the CPU 801, one or more of the method 200, the process 300, the process 330, the process 400, the process 500 and the process 600 described above may be executed.

The present disclosure may be a method, an apparatus, a system, and/or a computer program product. The computer program product may include a computer-readable storage medium, on which computer-readable program instructions for executing various aspects of the present disclosure are loaded.

The computer-readable storage medium may be a tangible device, which may hold and store instructions used by an instruction execution device. The computer-readable storage medium may be, for example, but is not limited to, an electrical storage device, a magnetic storage device, an optical storage device, an electromagnetic storage device, a semiconductor storage device, or any suitable combination thereof. More specific examples of the computer-readable storage medium (a non-exhaustive list) include: a portable computer disk, a hard disk, a random access memory (RAM), a read-only memory (ROM), an erasable programmable read-only memory (EPROM or a flash memory), a static random access memory (SRAM), a portable compact disc read-only memory (CD-ROM), a digital versatile disk (DVD), a memory stick, a floppy disk, a mechanical encoding device, such as a punched card or a protrusion structure in a groove, on which an instruction is stored, and any suitable combination thereof. The computer-readable storage medium, as used herein, is not to be interpreted as a transient signal per se, such as radio waves or other freely propagating electromagnetic waves, electromagnetic waves propagating via waveguides or other transmission media (e.g., light pulses propagating via optical fiber cables), or electrical signals transmitted via electrical wires.

The computer-readable program instructions described herein may be downloaded from the computer-readable storage medium into various computing/processing devices, or downloaded into an external computer or external storage device via a network, such as the Internet, a local area network, a wide area network, and/or a wireless network. The network may include a copper transmission cable, optical fiber transmission, wireless transmission, a router, a firewall, a switch, a gateway computer, and/or an edge server. A network adapter card or network interface in each computing/processing device receives the computer-readable program instructions from the network, and forwards the computer-readable program instructions for storage in the computer-readable storage medium in each computing/processing device.

The computer program instructions used for executing the operations of the present disclosure may be assembly instructions, instruction set architecture (ISA) instructions, machine instructions, machine-related instructions, microcodes, firmware instructions, state setting data, or source codes or target codes compiled in any combination of one or more programming languages, the programming languages include object-oriented programming languages such as Smalltalk and C++, and conventional procedural programming languages such as a “C” language or similar programming languages. The computer-readable program instructions may be completely executed on a user computer, partly executed on the user computer, executed as a stand-alone software package, partly executed on the user computer and partly executed on a remote computer, or completely executed on a remote computer or a server. In the case where the remote computer is involved, the remote computer may be connected to the user computer through any kind of networks, including a local area network (LAN) or a wide area network (WAN), or, it may be connected to an external computer (for example, connected via the Internet using an Internet service provider). In some embodiments, an electronic circuit, such as a programmable logic circuit, a field programmable gate array (FPGA) or a programmable logic array (PLA), may be customized using the state information of the computer-readable program instructions. The electronic circuit may execute the computer-readable program instructions to implement various aspects of the present disclosure.

Here, various aspects of the present disclosure are described with reference to the flowcharts and/or block diagrams of the method, the apparatus (system) and the computer program product according to the embodiments of the present disclosure. It should be understood that, each block of the flowcharts and/or the block diagrams and combinations of various blocks in the flowcharts and/or the block diagrams may be implemented by the computer-readable program instructions.

These computer-readable program instructions may be provided for a general-purpose computer, a special-purpose computer or processing units of other programmable data processing apparatuses, so as to generate a machine, such that these instructions, when executed by the computers or the processing units of the other programmable data processing apparatuses, generate apparatuses used for implementing specified functions/actions in one or more blocks of the flowcharts and/or the block diagrams. These computer-readable program instructions may also be stored in the computer-readable storage medium, these instructions cause the computers, the programmable data processing apparatuses and/or other devices to work in particular manners, such that the computer-readable storage medium storing the instructions includes a manufacture, which includes instructions for implementing the various aspects of the specified functions/actions in one or more blocks of the flowcharts and/or the block diagrams.

The computer-readable program instructions may also be loaded on the computers, the other programmable data processing apparatuses or the other devices, so as to execute a series of operation steps on the computers, the other programmable data processing apparatuses or the other devices to produce processes implemented by the computers, such that the instructions executed on the computers, the other programmable data processing apparatuses or the other devices implement the specified functions/actions in one or more blocks of the flowcharts and/or the block diagrams.

The flowcharts and the block diagrams in the drawings show system architectures, functions and operations that may be implemented by the system, the method and the computer program product according to a plurality of embodiments of the present disclosure. In this regard, each block in the flowcharts and the block diagrams may represent a part of a module, a program segment or an instruction, and the part of the module, the program segment or the instruction contains one or more executable instructions for implementing specified logical functions. In some alternative implementations, the functions annotated in the blocks may also occur in a different order from the order annotated in the drawings. For example, two consecutive blocks may actually be executed substantially in parallel, or they may sometimes be executed in a reverse order, depending on the functions involved. It should also be noted that, each block in the block diagrams and/or the flowcharts, and the combination of the blocks in the block diagrams and/or the flowcharts may be implemented by a dedicated hardware-based system that is used for executing the specified functions or actions, or it may be implemented by a combination of dedicated hardware and computer instructions.

The various embodiments of the present disclosure have been described above, and the above description is exemplary, not exhaustive, and is not limited to the various disclosed embodiments. Without departing from the scope and spirit of the various described embodiments, many modifications and changes are obvious to those ordinary skilled in the art. The choice of the terms used herein is intended to best explain the principles of various embodiments, practical applications, or improvements to the technology in the market, or to enable other ordinary skilled in the art to understand the various embodiments disclosed herein.

1. A method for image processing, comprising:
acquiring a training data set comprising a medical image and a corresponding annotated text, wherein the annotated text comprises classification information of the medical image and descriptive information associated with the classification information; and
training an image interpretation model using the training data set, wherein the image interpretation model comprises a first computing model for extracting an image feature from the medical image and a second computing model for generating a text from the image feature.

2. The method according to claim 1, wherein the descriptive information is applicable for interpreting the classification information base on medical standards.

3. The method according to claim 1, wherein extracting the image feature from the medical image using the first computing model comprises:
determining, based on an image channel of the medical image, an image channel weight set associated with the image channel;
determining, based on spatial distribution of objects in the medical image, a spatial weight set associated with a space; and
determining the image feature on the basis of the image channel weight set and the spatial weight set.

4. The method according to claim 1, wherein the second computing model comprises a sequence-to-sequence model, and wherein the sequence-to-sequence model comprises a plurality of predicting units connected in series, and each of the predicting units is configured to output a predicted word or phrase.

5. The method according to claim 4, wherein training the image interpretation model using the training data set comprises: for a predicting unit among the plurality of predicting units connected in series,
receiving, by the predicting unit, a word or phrase generated by a previous predicting unit as an input; and
outputting, by the predicting unit, a predicted word or phrase to a next predicting unit.

6. The method according to claim 5, wherein receiving, by the predicting unit, a word or phrase generated by a previous predicting unit as an input comprises:
in a first predicting unit, determining, based on the image feature and attention of the image feature, a first semantic feature associated with the image feature;
determining, based on the first semantic feature, a probability distribution of the word or phrase output from the first predicting unit;
in a second predicting unit, generating, based on the first semantic feature and the attention of the first semantic feature, a second semantic feature associated with the first semantic feature; and
determining, based on the second semantic feature, a probability distribution of the word or phrase output from the second predicting unit.

7. The method according to claim 4, wherein training the image interpretation model using the training data set comprises:
performing word segmentation on texts in the training data set to acquire a lexicon for generating the text; and
training the second computation model based on the lexicon to cause words or phrases in the text generated by the second computation model to be comprised in the lexicon.

8. The method according to claim 1, wherein the first computing model comprises at least a part of a pre-trained model, and training the image interpretation model using the training data set comprises:
freezing parameters of the first computing model; and
updating parameters of the second computing model.

9. (canceled)

10. The method according to claim 1, further comprising:
generating, from the input medical image, classification information of the input medical image and a descriptive text for interpreting the classification information using the trained image interpretation model.

11. A device, comprising:
at least one processor; and
at least one memory coupled to the at least one processor and having stored instructions for execution by the at least one processor, wherein the instructions, when executed by the at least one processor, cause the at least one processor to:
acquire a training data set comprising a medical image and a corresponding annotated text, wherein the annotated text comprises classification information of the medical image and descriptive information associated with the classification information; and
train an image interpretation model using the training data set, wherein the image interpretation model comprises a first computing model for extracting an image feature from the medical image, and a second computing model for generating a text from the image feature.

12. The device according to claim 11, wherein the descriptive information is applicable for interpreting the classification information based on medical standards.

13. The device according to claim 11, wherein extracting the image feature from the medical image using the first computing model comprises:
determining, based on an image channel of the medical image, an image channel weight set associated with the image channel;
determining, based on spatial distribution of objects in the medical image, a spatial weight set associated with a space; and
determining the image feature on the basis of the image channel weight set and the spatial weight set.

14. The device according to claim 11, wherein the second computing model comprises a sequence-to-sequence model, and wherein the sequence-to-sequence model comprises a plurality of predicting units connected in series, and each of the predicting units is configured to output a predicted word or phrase.

15. The electronic according to claim 14, wherein training the image interpretation model using the training data set comprises: for a predicting unit among the plurality of predicting units connected in series,
receiving, by the predicting unit, a word or phrase generated by a previous predicting unit as an input; and
outputting, by the predicting unit, a predicted word or phrase to a next predicting unit.

16. The device according to claim 15, wherein receiving, by the predicting unit, a word or phrase generated by a previous predicting unit as an input comprises:
in a first predicting unit, determining, based on the image feature and attention of the image feature, a first semantic feature associated with the image feature;
determining, based on the first semantic feature, a probability distribution of the word or phrase output from the first predicting unit;
in a second predicting unit, generating, based on the first semantic feature and the attention of the first semantic feature, a second semantic feature associated with the first semantic feature; and
determining, based on the second semantic feature, a probability distribution of the word or phrase output from the second predicting unit.

17. The device according to claim 14, wherein training the image interpretation model using the training data set comprises:
performing word segmentation on texts in the training data set to acquire a lexicon for generating the text; and
training the second computation model based on the lexicon to cause words or phrases in the text generated by the second computation model to be comprised in the lexicon.

18. The device according to claim 11, wherein the first computing model comprises at least a part of a pre-trained model, and training the image interpretation model using the training data set comprises:
freezing parameters of the first computing model; and
updating parameters of the second computing model.

19. The device according to claim 11, wherein the classification information comprises aided diagnosis information for the medical image, and the descriptive information comprises description for one or more objects of the medical image.

20. The device according to claim 11, wherein the instructions, when executed by the at least one processor, further cause the at least one processor to:
generate, from the input medical image, classification information of the input medical image and a descriptive text for interpreting the classification information using the trained image interpretation model.

21. A non-transitory computer-readable storage medium having stored a computer program comprising instructions, which, when executed by a processor, cause the processor to:
acquire a training data set comprising a medical image and a corresponding annotated text, wherein the annotated text comprises classification information of the medical image and descriptive information associated with the classification information; and
train an image interpretation model using the training data set, wherein the image interpretation model comprises a first computing model for extracting an image feature from the medical image, and a second computing model for generating a text from the image feature.
